(19) United States
(12) Patent Application Publication
(10) Pub. No.: US 2007/0034076 A1
(43) Pub. Date: Feb. 15, 2007

(54) Hydraulic power steering system

(75) Inventors: Imre Nagy, Eching (DE); Steffen Mueller, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/582,393

(22) Filed: Oct. 18, 2006

Related U.S. Application Data
(63) Continuation of application No. PCT/EP05/03763, filed on Apr. 9, 2005.

(30) Foreign Application Priority Data
Apr. 22, 2004 (DE) 10 2004 019 526.9

(51) Int. Cl. F15B 9/10

(52) U.S. Cl. 91/375 A

(57) ABSTRACT

A hydraulic power steering system for a motor vehicle with a rotary slide valve and a reaction piston which can be pressurized with hydraulic medium optionally on one of its two faces, where the reaction piston transfers, depending on the pressurization, a moment to the rotary slide, the moment changing the driver's manual moment at the steering handle such that a moment superimposed on the manual moment can also be generated, the superimposed moment leading to an increase or decrease of the manual moment or to a reversal of the direction of the manual moment. For the hydraulic pressurization of the reaction piston, a conveyance device driven by an electric motor is provided. Preferably, the conveyance device with the electric motor is mounted on the rotary slide valve and draws hydraulic medium from a tank recycling line.

This application is a continuation of International Application No. PCT/EP2005/003763, filed Apr. 9, 2005, and claims the priority of German patent application DE10 2004 019 526.9, filed Apr. 22, 2004, the disclosures of which are expressly incorporated by reference herein.

### BACKGROUND AND SUMMARY OF THE INVENTION

The invention relates to a hydraulic power steering system for a motor vehicle and with a rotary slide valve and a reaction piston which can be pressurized with hydraulic medium in a manner optionally variable to different intensities on its two faces, where the reaction piston transfers, depending on the pressurization, a moment to the rotary slide, the moment having as a consequence a change of the driver's manual moment resulting at the steering handle such that, in addition to a supporting moment, a moment superimposed on the manual moment can also be generated, where the superimposed moment leads to an increase or decrease of the manual moment or to a reversal of the direction of the manual moment. As technological background, reference is made to the unpublished German patent application 10 2004 002 248 along with the so-called Servotechnic® of the firm ZF-Lenksysteme (for example, described in the company publication G8000P-WG2/97d of ZF Friedrichshafen AG, Geschäftsbereich Lenkungstechnik, D-73522 Schwäbisch Gmünd).

In this unpublished German patent application a steering system is described which is based on a comparatively simple, and thus economical, hydraulic power steering system which is controlled with a hydraulic rotary slide valve which is actuated, via a torque rod, by the steering wheel (generally the steering handle for the driver of the vehicle) and in which, by opening an electro-hydraulic converter and by additional hydraulic elements, a pressure differential is generated at a reaction piston. In this way, a torque on the rotary slide is generated and leads to a change of the manual moment at the steering wheel. Along with this, in the customary, simple power steering system, depending on the direction of rotation of the rotary slide at the reaction piston, either a positive or a negative pressure differential and, via this, a moment supporting the manual moment can be generated. In the steering system according to the German patent application 10 2004 002 248 the reaction moment on the steering handle can be controlled independently of the amplitude and the direction of a steering command. The rotary slide valve of the hydraulic power steering system can therefore be modified in such a manner that, independently of the amplitude and the direction of rotation of the rotary slide relative to a control bushing of the rotary slide valve, a superimposed moment can be generated in addition to the supporting moment, where the superimposed moment leads to an increase or decrease of the manual moment or to a reversal of the direction of rotation of the manual moment. Thereby it is thus achieved that the manual moment of the steering handle can be changed arbitrarily with regard to amplitude and direction.

Thereby it is possible to indicate to the driver of the vehicle a situation which has changed with respect to the dynamics of driving, such as, for example, a tendency of the vehicle to oversteer or understeer when driving around a curve. The driver then senses, for example, a yielding of the steering wheel during her/his steering movement and is thereby forced to make a corresponding correction of her/his steering movement. Moreover, such a generation of a superimposed moment by means of a power steering device can be utilized in order to display an advantageous steering movement to the driver when the vehicle is entering or exiting a parking space. Finally, a logical steering direction can be displayed to the driver by generating a moment superimposed on the steering wheel while driving on the street so that the driver stops her/his vehicle within the lane to be used.

In the unpublished German Patent Application 10 2004 002 248 already mentioned, just as in the present invention, the so-called superimposed moment is generated by the device provided for generating the supporting moment. For this, the rotary slide valve is modified in a suitable manner and a hydraulic change-over circuit can be provided with which the supporting moment and the superimposed moment can be generated by reversing the active direction of an actuator. As an alternative to a change-over circuit, a hydraulic bridge circuit can be provided, with which the superimposed moment can be generated by changing the direction of pressure at an actuator.

Also, in the present invention, operation is possible with a modified rotary slide valve which in fact still comprises a customary reaction piston which can be pressurized with hydraulic medium from two sides, the reaction piston transferring, depending on the pressurization, a moment to the rotary slide, where the moment has as a consequence a change of the manual moment resulting at the steering handle.

Instead of a hydraulic bridge circuit or a change-over circuit however, other measures will be pointed out with whose aid the reaction piston, in a practically arbitrary manner (as individually desired), can be pressurized with hydraulic medium to a different intensity on both sides (i.e., the objective of the present invention).

In this connection let it be noted that a different hydraulic pressure on the two faces of the reaction piston is obviously only required when a moment, i.e., a supporting moment or a moment superimposed on the steering handle, is desired.

The realization of this objective for a hydraulic power steering system is characterized by the fact that, for the desired hydraulic pressurization of the reaction piston, one provides a conveyance device driven by an electric motor which can be controlled in a suitable manner, where the conveyance device draws hydraulic medium from an essentially pressureless section of the hydraulic circuit. Advantageous developments and extensions are described below.

It is thus proposed to pressurize the so-called reaction piston of an otherwise essentially customary rotary slide valve of a hydraulic power steering system with hydraulic medium from its circuit, where this pressurization can be varied with regard to intensity and direction, i.e., to which face of the reaction piston, which can be pressurized on both faces, the higher hydraulic pressure is applied, and in fact by means of a conveyance device for the hydraulic medium, where the conveyance device is driven by an electric motor which can be controlled in a selective manner. The control of the electric motor permits, in a simple manner, a nearly arbitrary adjustment of the pressure relationships at the reaction piston (and thus an arbitrary adjustment of the manual moment at the steering wheel or the like), where the electric motor can be suitably controlled for this purpose by an electronic control unit. In so doing, it is, for reasons of manufacturing, installation, and space, as well as in regard to the laying of hydraulic lines or ducts, particularly advantageous if the conveyance device with the electric motor is mounted on the rotary slide valve and draws hydraulic medium from a so-called tank recycling line of the hydraulic circuit of the power steering system.

If we are speaking here of the use of an otherwise essentially customary rotary slide valve of a hydraulic power steering system, let it be noted that it no longer has to comprise certain elements, such as, in particular, a final control element for generating different so-called supporting characteristic curves as a function of the driving speed of the vehicle (cf, regarding this, also the company publication named in the introduction). Such functionality can be demonstrated, specifically also with the proposed conveyance device which is driven by an electric motor and can be hydraulically connected to the two faces of the reaction piston.

The stated conveyance device can be formed as a cylinder-piston unit in which the cylinder and piston can be moved relative to one another by means of the electric motor and in which hydraulic chambers are provided on both sides of the piston, where the hydraulic chambers are each hydraulically connected to a face of the reaction piston. Apart from the fact that such a conveyance device is distinguished by a simple mode of construction, and consequently by simple and reliable function, this conveyance device permits an extremely sensitive adjustment of the pressure relationships at the reaction piston and in fact also due to a suitably settable gear transmission ratio of the gear mechanism provided between the electric motor and the (for example) piston driven by it. Different developments of this form of embodiment, in particular with regard to the hydraulics, will be described in still more detail at a later point as preferred embodiment examples.

In an alternative form of embodiment the conveyance device can be formed in the form of a pump with a reversible direction of conveyance and driven by the electric motor, where the hydraulic circuitry is preferably configured in such a manner that, as a function of the direction of conveyance of the pump, one or the other face of the reaction piston is pressurized with a positive pressure differential and where the reversal of direction can be effected by the electric motor in a simple manner and without complicated valves. Along with this it is possible to operate the electric motor only under control and not under regulation and in fact particularly when throttled bypass lines leading to a pressureless section of the hydraulic circuit branch off from the hydraulic lines leading to the reaction piston. With a suitable design of the throttles there is a quasi-self-regulating system which is not disturbed by additional input variables, namely in the form of a steering handle actuation by the driver. It is however also possible to regulate the conveyance capacity of the pump taking into account additional variables, for which it is recommended to provide, in particular in the hydraulic lines leading to the reaction piston, or to its two faces, pressure sensors whose measured values are taken into account in the control of the electric motor.

Likewise, the electric motor can be controlled taking into account the pressures in the hydraulic lines leading from the conveyance device to the faces of the reaction piston, where the pressures are recorded by means of pressure sensors, if the conveyance device is formed as a cylinder-piston unit whose piston is displaced with respect to the cylinder (preferably) by means of the electric motor. Thus, the electric motor or the piston can then be “run in response” to the commands of the driver through her/his steering handle and, for this, generating a desired superimposed moment. Alternatively however, “self-regulation” is also possible in the case of a cylinder-piston unit as the conveyance device, i.e., that the piston does not have to be run in response to the driver's commands, specifically when a gear mechanism between the electric motor and the piston moved by it is formed so as to be non-self-inhibiting, i.e., that under the influence of hydraulic forces the piston of the cylinder-piston can be displaced independently of the electric motor.

Other objects, advantages and novel features of the present invention will become apparent from the following detailed description of the invention when considered in conjunction with the accompanying drawings.

### BRIEF DESCRIPTION OF THE DRAWINGS

FIG. 1 shows the principle of a first form of embodiment of the present invention.

FIG. 2 shows the cylinder-piston unit (as a conveyance device) of FIG. 1 represented in more detail.

FIGS. 3, 4 show further embodiments of the embodiment according to FIG. 1.

FIG. 5 shows another embodiment of the present invention with a pump as a conveyance device.

In all the figures, the same elements bear the same reference numbers.

### DETAILED DESCRIPTION

The reference number 1 denotes a so-called reaction piston in a rotary slide valve of an essentially customary power steering system. The reaction piston 1 can be displaced according to the arrow's direction 2 in a cylinder 3 not represented in more detail, for which the two faces la or lb of the reaction piston 1 can be pressurized with different hydraulic pressure in their respective spaces 3a or 3b in the cylinder. A higher pressure in the cylinder's annular space 3a, on the left side in the figure and perpendicular to the plane of the drawing, induces a displacement of the reaction piston 1 to the right and a higher pressure in the cylinder's annular space 3b, on the right side in the figure and perpendicular to the plane of the drawing, induces a displacement of the reaction piston 1 to the left. This type of displacement of the reaction piston 1 leads, as is known and explained above, to a change of the so-called manual moment at the steering handle (a steering wheel) of a motor vehicle which is equipped with such a power steering system.

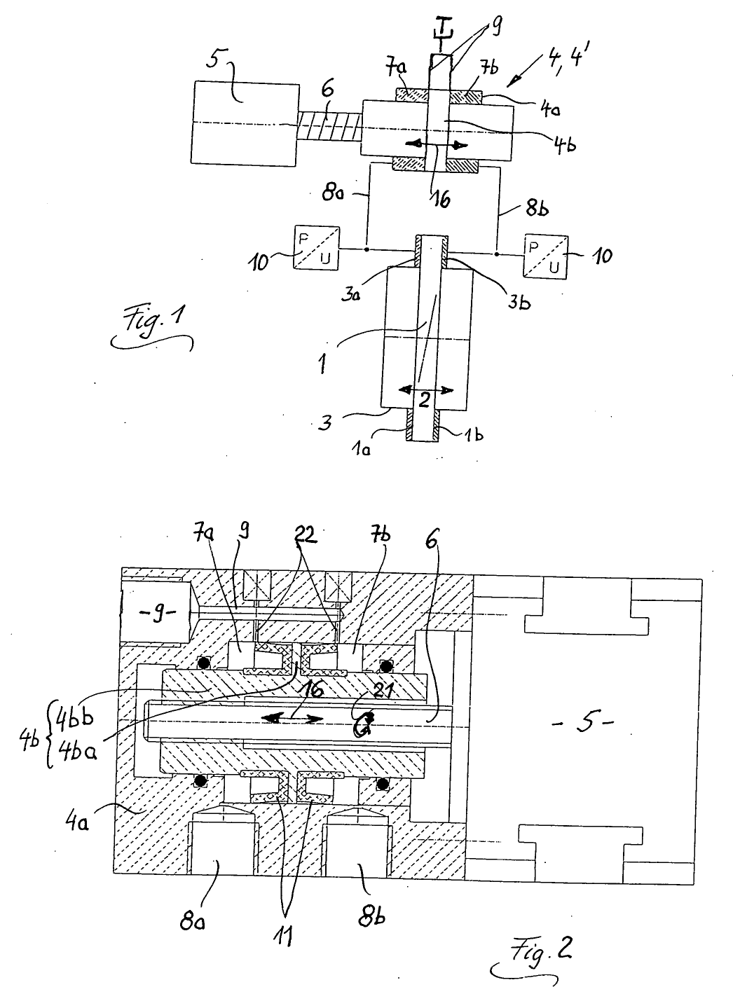

In order to be able to apply different hydraulic pressure at the two faces 1a, 1b of the reaction piston 1 or in the spaces 3a or 3b in the cylinder spaces, a conveyance device 4 is provided which, for this purpose, can be driven in a suitable manner by an electric motor 5. In the embodiment examples according to FIGS. 1-4 the conveyance device 4 is formed as a cylinder-piston unit 4′ with a piston 4b guided in a cylinder 4a according to the arrow's direction 16 in such a manner that it can be displaced in the longitudinal direction (but cannot be rotated), where the piston is connected via a suitable gear mechanism 6, embodied here in the form of a threaded spindle, to the electric motor 5 or to its drive shaft. On both sides of the piston 4b, annular hydraulic chambers 7a, 7b are thus formed in the cylinder 4a and perpendicular to the plane of the drawing, where each of the hydraulic chambers is connected via a hydraulic line 8a or 8b to one of the cylinder's annular spaces 3a or 3b, that is, the hydraulic chamber 7a is connected to the first face 1a and hydraulic chamber 7bis connected to the second face lb of the reaction piston 1.

Emptying into each hydraulic chamber 7a, 7b is a supply line 9 via which hydraulic medium from an essentially pressureless section of the hydraulic circuit of the power steering system, that section being denoted by the letter T (for tank), can arrive in the respective hydraulic chamber 7a, 7b. In the embodiment example according to FIG. 1 the supply line 9 empties in each case directly next to the piston 4b if it is in its starting position or neutral position in the center of the cylinder 4a. As soon as the piston 4a is displaced starting from this neutral position, e.g., to the left, then the intake opening of the supply line in the left hydraulic chamber 7a is closed so that in case of a further displacement of the piston 4a in this direction (to the left), a partial amount of the hydraulic medium in the hydraulic chamber 7a is expelled via the hydraulic line 8a towards the face 1a of the reaction piston 1. Along with this, at each of the hydraulic lines 8a and 8b a pressure sensor 10 is provided whose signals, namely the signals reproducing the current pressure in the respective hydraulic line 8a or 8b, are conducted to an electronic control device not represented, which, as has been explained above, also controls the electric motor 5 according to the present requirements, taking into account the pressure values.

In FIG. 2 the cylinder-piston unit 4′ from FIG. 1, together with the electric motor 5 flange-mounted thereon, is represented in somewhat more detail. According to this figure, the piston 4b is composed of a so-called active section 4ba, which works together with the hydraulic chambers 7a, 7b, or changes their volume, and a so-called guide section 4b, which works together with the gear mechanism 6 in the form of a threaded spindle. Along with this but not represented in the figures is the element provided on the guide section 4bb and restraining the piston 4b against rotation, where the restraining element prevents the piston 4, on rotation of the threaded spindle 6 according to the arrow's direction 21, from being unscrewed off it, ensuring instead that the piston 4b is then displaced in the longitudinal direction according to the arrow's direction 16.

Seen in FIG. 2 are sealing elements 11 provided on both sides of the so-called active section 4ba of the piston 4b, where the two supply lines 9 obviously do not empty, via so-called “snifting holes” 22 in the wall of the cylinder 4a, immediately next to the piston 4b in the neutral position but instead essentially directly next to these sealing elements 11 in the respective hydraulic chambers 7a, 7b. The hydraulic lines 8a, 8b, on the contrary, branch out from the end section of the respective hydraulic chambers 7a, 7b.

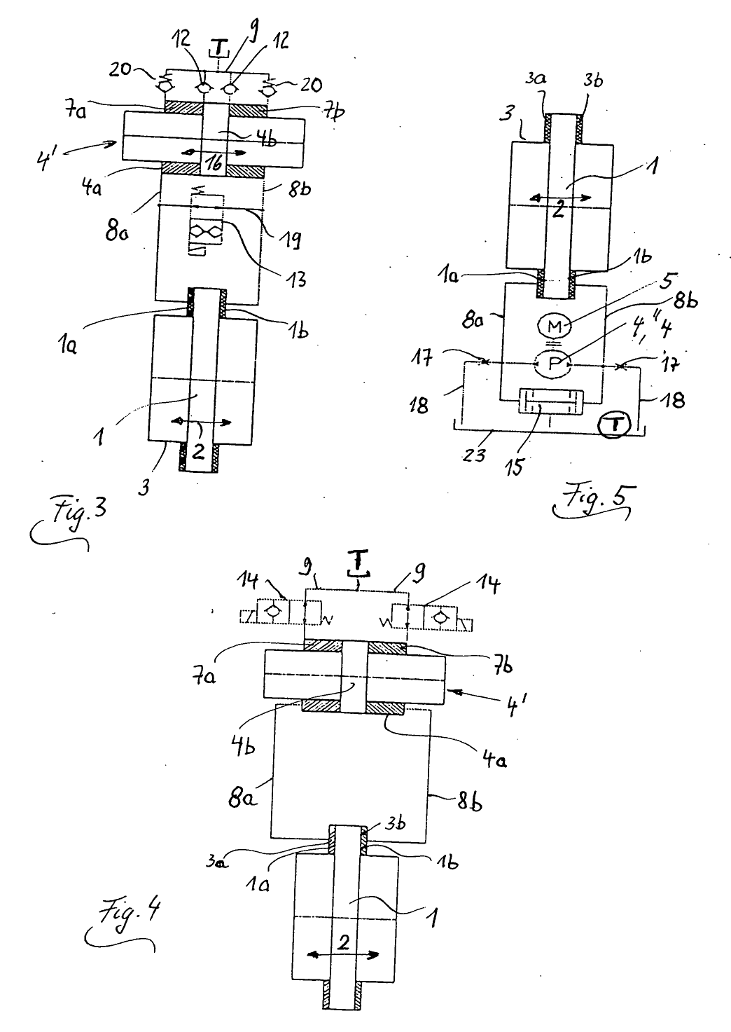

Because it cannot be ensured that the piston 4b in its starting position is always precisely in the center of the cylinder 4a, cases could arise in which, with a slight displacement of the piston 4b, hydraulic medium is first expelled, via the respective snifting hole 22 and the supply line 9 connecting to it, from the hydraulic chambers 7a, 7b which are reducing in size, and in fact until the piston 4b, or its respective sealing element 11, has covered the respective so-called “snifting hole” 22. In order to prevent this possibly undesired effect, in the embodiment example according to FIG. 3 check valves 12 opening towards the hydraulic chambers 7a, 7b are provided in the supply lines 9 leading into the “snifting holes” 22. Pressure-controlled relief valves 20 are connected in parallel to these check valves for reasons of safety.

Furthermore, FIG. 3 shows, between the hydraulic lines 8a, 8b leading from the hydraulic chambers 7a, 7b to the reaction piston 1, a connecting safety line 19 provided with a de-energized, open stop valve 13. Should any faults occur, then this stop valve 13 can be opened, if it has not already been opened anyway due to insufficient supply of current, whereby the two hydraulic lines 8a, 8b are connected to one another in a short-circuit so that no undesired pressurization of the reaction piston 1 with hydraulic pressure can take place. Although such a connecting safety line 19 is only represented in this figure, it can obviously also be provided in all the other embodiment examples.

In the embodiment example according to FIG. 4 the hydraulic supply lines 9 of the cylinder-piston unit 4′ empty into the hydraulic chambers 7a, 7b essentially on the end side of the piston 4b lying in the starting position in the center of the cylinder 4a and suitably switchable stop valves 14 are provided in the hydraulic supply lines 9. With this configuration of the supply lines 9 it is ensured that, independently of the position of the piston 4b in the cylinder 4a, each hydraulic chamber 7a, 7b can be filled with hydraulic medium when the piston 4b is idle. However, to achieve the desired function when the piston 4b is moved to reduce one of the two hydraulic spaces 7a, 7b, the stop valve 14 assigned to it must be closed, if it is not already closed. Advantageously, here these stop valves 14 are formed as change-over valves which can change over from the unobstructed-flow state to the check valve state and vice versa.

In the embodiment example according to FIG. 5 the conveyance device 4 is formed in the form of a pump 4″ driven by the electric motor 5 and with a reversible direction of conveyance, where the hydraulic circuitry is configured in such a manner that, as a function of the direction of conveyance of the pump 4″, the first face 1a or the second face 1b of the reaction piston 1 is pressurized with a positive pressure differential. On the suction side of the pump a so-called alternating check valve 15 is provided in circuitry customary for this, where the alternating check valve ensures that from the respective pressure side of the pump 4″ no hydraulic medium can arrive directly in a tank 23 from which the pump conveys or the like, i.e., generally in an essentially pressureless section T of the hydraulic circuit of the power steering system, while this alternating check valve 15 has simultaneously disconnected a connection between the pump suction side and this tank 23 or pressureless section T. Alongside this however, bypass lines 18 provided with suitable throttles 17 and leading to a pressureless section T of the hydraulic circuit branch off from the hydraulic lines 8a, 8b leading to the reaction piston 1. Thus, with suitable design of these throttles 17, there is a quasi-self-regulating system which is not disturbed by additional input variables, namely in the form of a steering handle actuation by the driver, which also have an effect on the hydraulic pressure on the faces 1a, 1b of the reaction piston 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hydraulic power steering system for a motor vehicle, comprising:
a rotary slide valve;
a reaction piston having two faces; and
a conveyance device driven by an electric motor for applying hydraulic pressure to the reaction piston,
wherein
when the reaction piston is pressurized with a hydraulic medium, the reaction piston transfers a moment to the rotary slide,
the moment transferred to the rotary slide changes a driver's manual moment at a steering handle of the motor vehicle such that, in addition to a supporting moment, a moment superimposed on the manual moment is also generated, where the superimposed moment at least one of increases or decreases the manual moment and reverses the direction of the manual moment, and
for the hydraulic pressurization of the reaction piston, the conveyance device draws the hydraulic medium from an essentially pressureless section of the hydraulic power steering system.

2. The power steering system according to claim 1, wherein the conveyance device with the electric motor is mounted on the rotary slide valve and draws the hydraulic medium from a tank recycling line.

3. The power steering system according to claim 1, wherein the conveyance device is a cylinder-piston unit in which a cylinder and a piston of the cylinder-piston unit are displaceable relative to one another by the electric motor, and in which hydraulic chambers are provided at both sides of the piston of the cylinder-piston unit which are each hydraulically connected to a face of the reaction piston.

4. The power steering system according to claim 3, wherein hydraulic supply lines of the cylinder-piston unit empty into the hydraulic chambers directly on both sides of the piston of the cylinder-piston unit when the piston of the cylinder-piston unit is lying in a starting position in a center of the cylinder of the cylinder-piston unit.

5. The power steering system according to claim 4, wherein check valves opening towards the hydraulic chambers are provided in the supply lines.

6. The power steering system according to claim 3, wherein hydraulic supply lines of the cylinder-piston unit empty into the hydraulic chambers essentially on the end side of the cylinder-piston unit piston when the piston of the cylinder-piston unit is lying in a starting position in a center of the cylinder, switchable stop valves are provided in the hydraulic supply lines.

7. The power steering system according to claim 3, wherein between hydraulic lines leading from the hydraulic chambers to the reaction piston, a connecting safety line is provided with a stop valve which is open when de-energized.

8. The power steering system according to claim 1, wherein the conveyance device is a pump with a reversible direction of conveyance and is driven by the electric motor.

9. The power steering system according to claim 8, wherein throttled bypass lines leading to a pressureless section of the hydraulic power steering system branch off from hydraulic lines leading to the reaction piston.

10. The power steering system according to claim 1, wherein pressure sensors are provided at hydraulic lines leading to the reaction piston, and the electric motor is controlled in response to measured pressure values detected by the pressure sensors.
